(19) United States
(12) Patent Application Publication
(10) Pub. No.: US 2004/0038024 A1
(43) Pub. Date: Feb. 26, 2004

(54) Adhesive tape for polishing pad and polishing tape

(75) Inventors: Kazuei Yamaguchi, Tokyo (JP); Hiromitsu Okuyama, Tokyo (JP)

Correspondence Address: BEYER WEAVER & THOMAS LLP, P.O. BOX 778, BERKELEY, CA, 94704-0778, US

(73) Assignee: NIHON MICROCOATING CO, LTD.

(21) Appl. No.: 10/646,382

(22) Filed: Aug. 21, 2003

(30) Foreign Application Priority Data
Aug. 23, 2002 (JP) 2002-242926

(51) Int. Cl. B32B 15/04

(52) U.S. Cl. 428/343

(57) ABSTRACT

An adhesive tape of the double-side type for attaching a polishing pad to a polisher and for backing a polishing pad and a polishing tape has a base sheet with both its front and back surfaces coated with an adhesive agent and a peeling sheet of a resin material is adhesively attached onto at least one of the surfaces of the base sheet. The peeling sheet may be made of polyethylene terephthalate or polypropylene and is treated such that it can be peeled easily.

### BACKGROUND OF THE INVENTION

This invention relates to an adhesive tape for a polishing pad or a polishing tape. In particular, this invention relates to an adhesive tape of a single-side or double-side type for securely attaching a polishing pad to a polisher or for serving as the lining of a polishing pad or a polishing tape.

Polishing pads have conventionally been used for the final polishing of hard disks and semiconductors, and polishing tapes have been used for texturing and cleaning hard disks. When a polishing pad is affixed to a polisher or when a lining is attached to a polishing tape in order to improve its strength against stretching or bending, cushioning ability or water-holding ability, it has been known to make use of an adhesive tape of a single-side or double-side type.

Functional properties of such adhesive tapes are evaluated numerically in terms, for example, of adhesive force, shear adhesive force, initial adhesive force, tensile strength and extension. Adhesive tapes have conventionally been selected by paying special attention to the adhesive force when they are to be used as the lining of a polishing tape. When a polishing pad is securely attached to a polisher, for example, the smoothness characteristic of the front (polishing) surface of the polishing pad is affected by the small protrusions and indentations on the surface of the adhesive agent on the double-side adhesive tape adhesively attached to the back surface of the polishing pad. Such small protrusions and indentations on the surface of the adhesive agent are generated by those on the peeling paper on the adhesive tape. In the past, the effect of the small protrusions and indentations on the surface of the adhesive agent on the smoothness characteristic of a polishing pad or a polishing tape was small enough to be negligible.

Recently, however, hard disks with higher capacities are produced, and since smoother surfaces are coming to be required in the polishing process for their production, the effect of such small protrusions and indentations on the surface of the adhesive agent on the smoothness characteristic of a polishing pad or a polishing tape is no longer negligible. Another important problem is how to improve the adhesive force of an adhesive tape without increasing its production cost.

### SUMMARY OF THE INVENTION

It is therefore an object of this invention in view of the above to provide an adhesive tape of either a single-side or a double-side type for a polishing pad and a polishing tape, capable of minimizing the protrusions and indentations on the surface of the adhesive agent and thereby improving the polishing capability of the polishing pad and the polishing tape.

It is another object of this invention to provide a polishing pad and a polishing tape, capable of improving the adhesive characteristic of its adhesive tape without increasing the production cost.

An adhesive tape embodying this invention may be characterized as being a double-side adhesive tape for attaching a polishing pad to a polisher and for backing a polishing pad and a polishing tape, and comprising a base sheet having a front surface and a back surface both coated with an adhesive agent and a peeling sheet of a resin material adhesively attached onto at least one of the surfaces of the back surface. The peeling sheet may comprise polyethylene terephthalate or polypropylene treated such that it can be peeled easily. The base sheet may comprise a resin material such as polyethylene terephthalate, vinyl chloride and cellophane or a paper, cloth, metal or foamed material. The adhesive may be an inorganic adhesive agent such as cement, a silicate, a phosphate and gypsum, or an organic adhesive agent such as a natural polymer, a semi-synthetic polymer and a synthetic polymer.

An adhesive tape embodying this invention for serving as a lining for a polishing pad or a polishing tape may be characterized as comprising a lining sheet having a surface coated with an adhesive agent and a peeling sheet of a resin material such as polyethylene terephthalate or polypropylene adhesively attached to the surface of the lining sheet coated with the adhesive agent.

### BRIEF DESCRIPTION OF THE DRAWINGS

FIG. 1 A is a sectional view of an example of polishing tape embodying this invention.

FIGS. 2A, 2B, 2C and 2D, together referred to as FIG. 2, show the surface conditions of the adhesive agent after peeling sheets have been peeled off from polishing tapes of the double-side type of both prior art kinds and this invention.

FIG. 3 is a graph showing the surface waviness of an aluminum substrate polished by using a prior art double-side polishing tape and a double-side polishing tape embodying this invention.

### DETAILED DESCRIPTION OF THE INVENTION

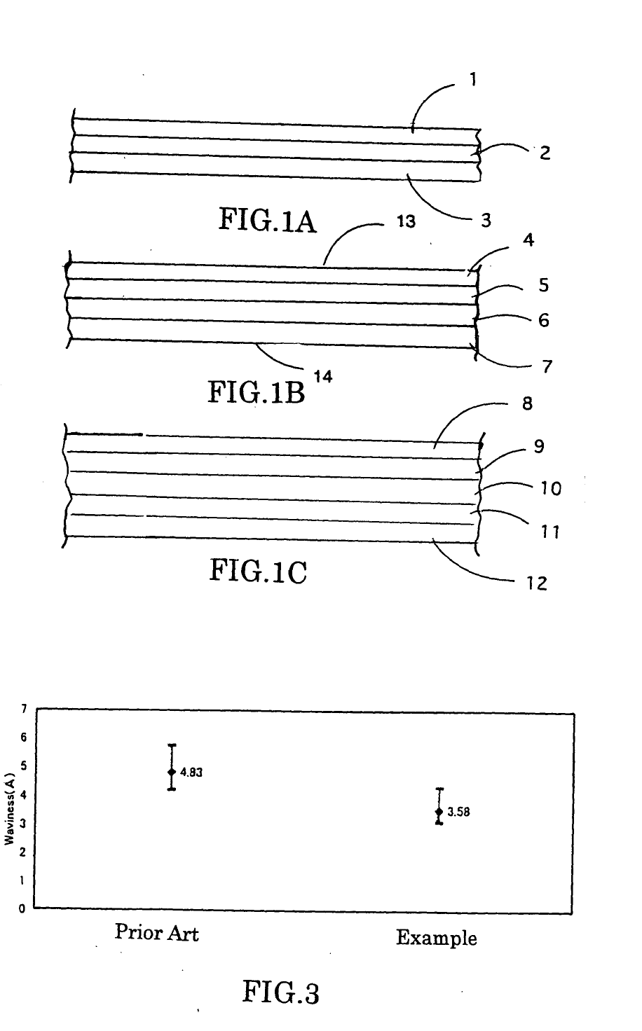

The invention is described next by way of examples with reference to the drawings. FIG. 1A shows an example of an adhesive tape of a single-side type serving as a lining, having a lining sheet 1 with its back surface coated with an adhesive agent 2. The lining sheet 1 may preferably comprise a resin such as polyethylene terephthalate (PET) but may also comprise a different substance such as a rubber, paper, cloth, metal or foamed material. The adhesive agent 2 may be an inorganic adhesive agent such as cement, a silicate, a phosphate and gypsum, or an organic adhesive agent such as a natural polymer, a semi-synthetic polymer and a synthetic polymer. A peeling sheet 3 is adhesively attached to the back surface of the adhesive agent 2. The peeling sheet 3 may preferably comprise PET but may also be of a resin material such as polypropylene (PP). The contact surface between the peeling sheet 3 and the adhesive agent 2 is coated with silicon such that the peeling sheet 3 can be peeled off easily. When the adhesive tape is used as a lining, the peeling sheet 3 is peeled off and the adhesive tape is adhesively attached to the back surface of a polishing pad or a polishing tape.

FIG. 1B shows an example of an adhesive tape of a double-side type serving as a lining or for securing attaching a pad, having a base sheet 6 with its front and back surfaces coated with an adhesive agent (shown at 5 and 7). The base sheet 6 may comprise a resin such as PET, vinyl chloride and cellophane, or another material such as a rubber, paper, cloth, metal or foamed material. A peeling sheet 4 is adhesively attached to the upper surface (as shown) of the adhesive agent 5. The peeling sheet 3 may preferably comprise PET but may also be of a resin material such as PP. The adhesive tape of a double-side type is usually rolled up in the form of a roll and the upper surface 13 of the peeling sheet 4 is in contact with the lower surface (as shown) 14 of the adhesive agent 7. For this purpose, both front and back surfaces of the peeling sheet 4 are coated with silicon such that the peeling sheet 4 can be peeled off easily. When a polishing pad is to be securely attached to a polisher, the lower adhesive surface 14 is contacted with the back surface of the polishing pad first so as to adhesively attach the double-side tape and then the peeling sheet 4 is removed to adhesively attach the adhesive surface to the surface of the polisher. When it is used as the lining of a polishing pad or a polishing tape, the lower adhesive surface 14 of the adhesive tape of FIG. 1B is adhesively attached to the back surface of the polishing pad or the polishing tape and after the peeling sheet 4 is removed, a lining sheet is attached thereonto.

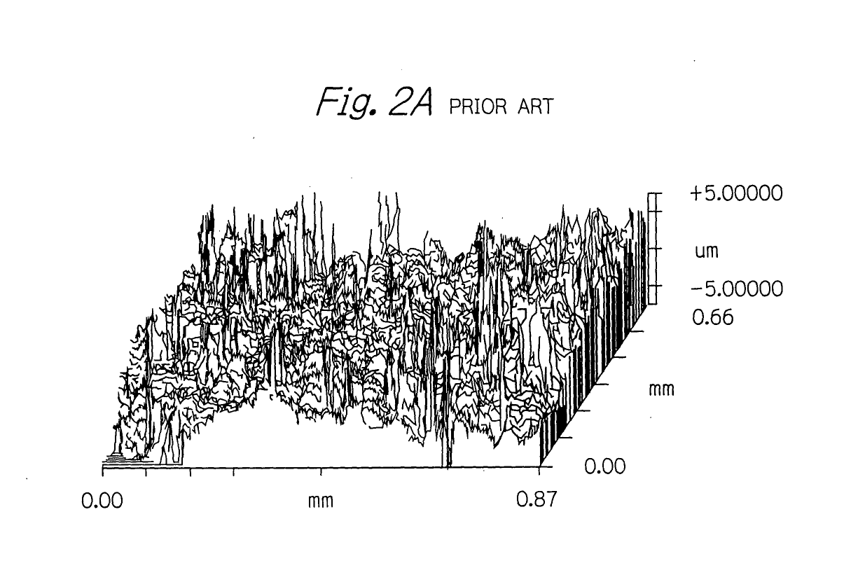

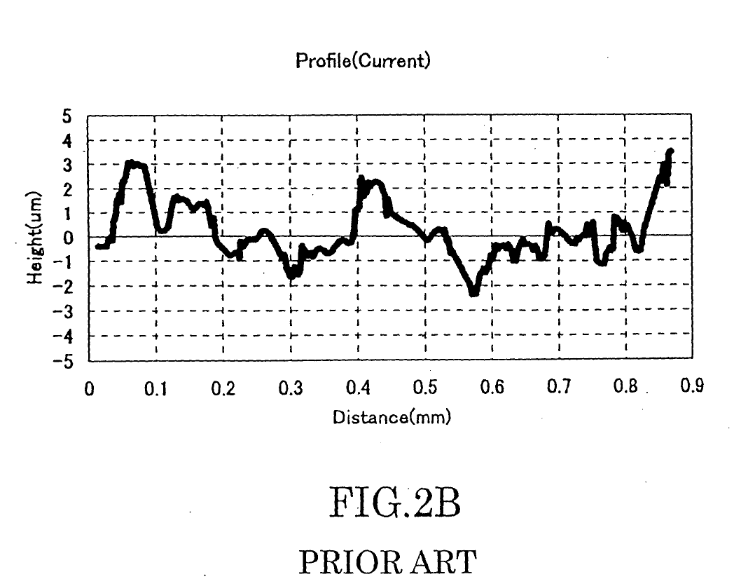

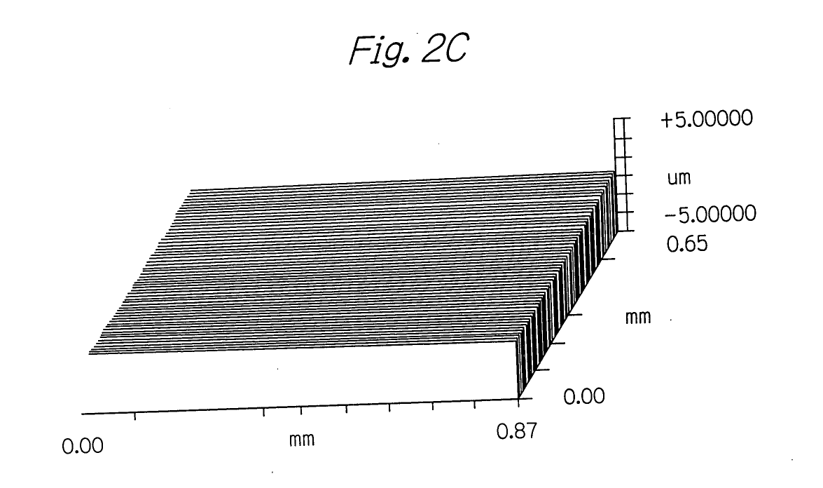

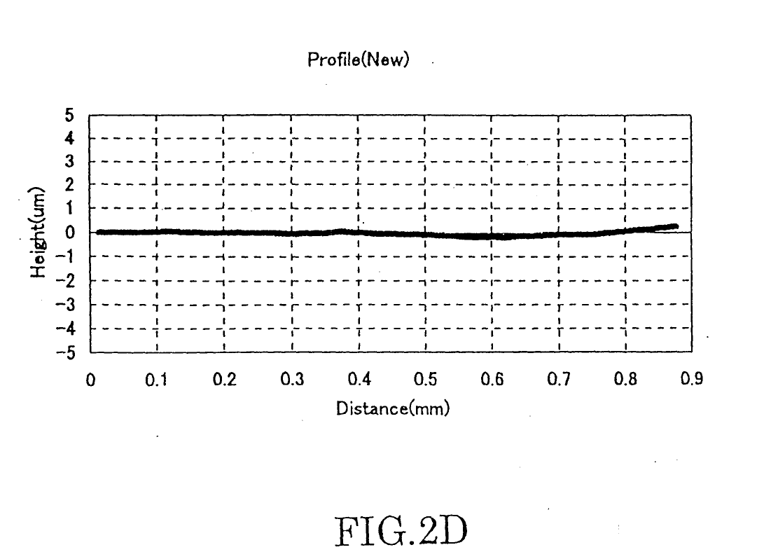

Prior art tapes of the double-side type were poor in their smoothness characteristic because the peeling sheet was of a paper material and small protrusions and indentations were generated on the surface of the adhesive agent when the peeling sheet was peeled off. FIG. 2 shows the difference in the surface condition of the adhesive agent observed by a scan-type white-light interferometer after peeling sheets have been peeled off for the case of a prior art tape with peeling sheets made of paper and a polishing tape of this invention with peeling sheets made of PET (polyethylene terephthalate). FIGS. 2A and 2C show the protrusions and indentations in the Z-direction in units of ±5 m over an area of 0.87 mm in the X-direction and 0.65 mm in the Y-direction respectively of a prior art tape and a tape of this invention. FIGS. 2B and 2D show the X-Z plane at the middle point in the Y-direction (where the Y-coordinate is 0.325 mm) respectively on the prior art tape and the tape of this invention. The conditions of these measurements are shown in Table 1 below:

TABLE 1

| | Scan-type white-color interferometer New |
|---|---|
| Device used | View 5000 (produced by Zygo, Inc.) |
| Objective lens | 10x |
| Intermediate lens | 0.8x |
| Filter (cutoff) | None |
| Width of observation | 100 μm |
| (in Z-direction) | |
| Type of tape | Double-side |
| Tape material | PET |
| Adhesive agent | Acrylic polymer |

On the basis of these observations, the center line average roughness (Ra) and the maximum height (PV) were measured. The results of the measurements are summarized in Table 2. In FIG. 2A, although the protrusions and indentations are shown over a width of ±5 μm, it is only for the sake of convenience. The read width of observation was over 100 μm including unobservable regions. Such steep protrusions and indentations are thought to be due to insufficient reflected light that made the observation impossible or beyond the limit of observation by the device.

TABLE 2

| Peeling sheet | Paper | PET |
|---|---|---|
| Ra (μm) | 1.33 | 0.11 |
| PV (μm) | 98.01 | 1.04 |

The results of measurement in Table 2 clearly demonstrate that the smoothness of the surface of the adhesive agent is significantly improved by replacing the peeling sheet of paper with that of PET.

FIG. 1 C shows another example of an adhesive tape of a double-side type serving as a lining or for securely attaching a pad, having a base sheet 10 (made of the same material as that of the base sheet 6 described above) with its front and back surfaces coated with an adhesive agent (shown at 9 and 11). Peeling sheets 8 and 12 are adhesively attached respectively to the top surface of the adhesive agent 9 and the bottom surface of the adhesive agent 11. The peeling sheets 8 and 12 may preferably comprise PET but may also be of a resin material such as PP. The contact surfaces between the peeling sheets 8 and 12 and the adhesive agents 9 and 11 are coated with silicon such that the peeling sheets 8 and 12 can be peeled off easily. When the polishing pad is to be securely attached to a polisher, the peeling sheet 12 is peeled off and the double-side tape is attached to the back surface of the polishing pad with the contact surface placed thereonto. The peeling sheet 8 is thereafter removed and the contact surface thus exposed is attached to the surface of the polisher.

When a lining is to be attached to a polishing pad or a polishing tape, the peeling sheet 12 of the adhesive tape of the double-side type of FIG. 1C is removed and the adhesive tape is attached to the back surface of the polishing pad or the polishing tape. Thereafter the other peeling sheet 8 is removed and a lining sheet is attached thereonto.

The invention is described next by way of a comparison test which has been carried out by using double-side adhesive tapes of both a prior art kind using paper and a kind according to this invention using PET. Polishing pads of a suede material (produced by Nihon Microcoating Co., Ltd.) were used for the polishing. PET was used for the base sheet of the double-side adhesive tape and an organic adhesive of acryl-type polymer as the adhesive agent. A polishing liquid was one (produced by Nihon Microcoating Co., Ltd.) containing about 5% of colloidal silica of average central particle diameter of about 80 nm and a polishing accelerator. Samples for the polishing were prepared by polishing 3.5-inch aluminum substrates, which had been subjected to an electroless nickel phosphate plating process, by using a polishing pad (Politex DG produced by Rodel Co., Ltd.) and a polishing liquid (DISKLITE3471 produced by Fujimi, Inc.) diluted with pure water at a ratio of 1:3. At this moment, the waviness (the average roughness measured at wavelengths in the range of 0.05 mm to 2.0 mm) was 6-8 Å.

Table 3 shows the other conditions of this comparison test.

TABLE 3

| | Double-side polisher HAMAI-9BF (produced |
|---|---|
| Polisher | by Hamai Sangyo Kabushiki Kaisha) |
| Applied pressure | 90 g/cm² |
| Rotation of lapping plate | 40 rpm |
| Supply of polishing | 0.2 liters/minute |
| liquid | |
| Polishing time | 4 minutes |
| Stock removal | about 1 μm |

After polishing pads were adhesively attached to a polisher by means of double-side tapes, a dummy running process was carried out for about 10 minutes in order to remove debris from the pads. A regular polishing process was carried out continuously ten times (on ten batches) thereafter and two samples were extracted from each batch (including ten sheets) and measurements were taken at two points each on the front surface and the back surface. These measurements were taken by using apparatus New View 5000 (produced by Zygo, Inc. with objective lens 10× and intermediate lens 0.8×) and cutting off wavelengths less than 0.05 mm and over 2.0 mm. The average roughness at each point was measured and micro-waviness was obtained.

FIG. 3 shows the measured result of waviness averaged over ten batches. It is seen that the waviness is about 4.8 Å if a peeling sheet made of paper is used but that it is about 3.6 Å if a peeling sheet made of PET according to this invention is used. It is important to reduce the waviness in the polishing of hard disks, and FIG. 3 shows clearly that the polishing characteristic is significantly improved by the present invention.

What is claimed is:

1. A double-side adhesive tape for attaching a polishing pad to a polisher and for backing a polishing pad and a polishing tape, said adhesive tape comprising:
a base sheet having a front surface and a back surface both coated with an adhesive agent; and
a peeling sheet of a resin material adhesively attached onto at least one of said front surface and said back surface.

2. The adhesive tape of claim 1 wherein said peeling sheet comprises a material selected from the group consisting of polyethylene terephthalate and polypropylene, said peeling sheet being processed to be made peelable.

3. The adhesive tape of claim 1 wherein said base sheet comprises a material selected from the group consisting of resin materials, rubber materials, paper materials, cloth materials, metals and foamed materials.

4. The adhesive tape of claim 3 wherein said resin materials include polyethylene terephthalate, vinyl chloride and cellophane.

5. The adhesive tape of claim 1 wherein said adhesive agent is one selected from the group consisting of inorganic adhesive agents and organic adhesive agents.

6. The adhesive tape of claim 5 wherein said adhesive agent is an inorganic adhesive agent selected from the group consisting of cement, silicates, phosphates and gypsum.

7. The adhesive tape of claim 5 wherein said adhesive agent is an organic adhesive agent selected from the group consisting of natural polymers, semi-synthesized polymers and synthesized polymers.

8. An adhesive tape for backing a polishing pad and a polishing tape, said adhesive tape comprising:
a lining sheet having a surface coated with an adhesive agent; and
a peeling sheet of a resin material adhesively attached to said surface of said lining sheet coated with said adhesive agent.

9. The adhesive tape of claim 8 wherein said peeling sheet comprises a material selected from the group consisting of polyethylene terephthalate and polypropylene, said peeling sheet being processed to be made peelable.
